(19) United States
(12) Patent Application Publication
(10) Pub. No.: US 2004/0205395 A1
(43) Pub. Date: Oct. 14, 2004

(54) Information recording/reproducing method, information recording/reproducing apparatus, and information recording medium

(76) Inventor: Tadashi Kojima, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/742,904

(22) Filed: Dec. 23, 2003

(30) Foreign Application Priority Data
Dec. 26, 2002 (JP) 2002-378277

(51) Int. Cl. H02H 3/05

(52) U.S. Cl. 714/21

(57) ABSTRACT

An information recording method has blocking an information and adding an error correction code to the information so as to generate an ECC block, adding plural kinds of synchronizing signals SY differently arranged according to a type of an information recording medium D (FIG. 4) or plural kinds of synchronizing signals SY having a signal pattern according to the type of the information recording medium to the generated ECC block at an predetermined interval, and recording a recording signal based on the ECC block in the information recording medium, is provided. Even if the whole information of a ROM medium is illegally copied, since it is detected by the arrangement of the synchronizing signals in the reproduction that the medium is a rewritable medium, countermeasure such as abortion of the reproduction can be made.

### CROSS-REFERENCE TO RELATED APPLICATIONS

This application is based upon and claims the benefit of priority from the prior Japanese Patent Application No. 2002-378277, filed Dec. 26, 2002, the entire contents of which are incorporated herein by reference.

### BACKGROUND OF THE INVENTION

1. Field of the Invention

The present invention relates to an information recording/reproducing method, particularly relates to an information recording/reproducing method and an information recording/reproducing apparatus which protect an illegal copy, in which the whole recording information recorded in a recording medium particularly such as a ROM (Read Only Memory) is copied with control information, by recording information for identifying a type of an information recording medium with contents information, and an information recording medium.

2. Description of the Related Art

Recently, in a system such as an optical disk in which various kinds of recording media such as DVD (Digital Versatile Disk)-ROM, DVD-R (Recordable) of a WO (Write Once) medium, and DVD-RW (Rewritable) and DVD-RAM (Random Access Memory) are present in the same basic frame, information to be recorded in a read-only recording medium such as DVD-ROM is often a case in which protection of copyright of data is required.

On the other hand, a rewritable recording medium such as DVD-RW and DVD-RAM is used in order that an end user records information received from other systems. In the case that data received from other systems is not permitted to record it by a copyright holder, though recording the data in the recording medium is prohibited, there is a violator who infringes the copyright to make illegally a copy. Therefore, recently a copy protection system is introduced in order to protect the copyright. In such situation, in the case that a read-only recording medium and a rewritable recording medium are present in the same platform, it is thought that the illegal copy is made falsifying the rewritable recording medium as if it was the read-only recording medium in such a manner that the whole information, which is recorded in the read-only recording medium and encrypted for the protection of the copyright, is recorded in the recording medium and marking is made as the read-only recording medium even in a medium identifying code.

A system of rejecting the illegal copy on the side of a reproducing apparatus is required against the recording medium in which the above-described illegal copy has been made. A measure of some kind is desired in the recording apparatus in which the illegal copy is made. A CSS (Content Scramble System), a CPPM (Content Protection for Prerecorded Media), or a CPRM (Content Protection for Recordable Media), which is a protection standard of the copyright concerning DVD, is known as the system of rejecting the illegal copy. The CSS is a technology for protecting a copyright which is licensed by DVD CCA (Copy Control Association), and the CPPM and CPRM are technologies for protecting a copyright which is licensed by 4C Entity, LLC.

“DVD CCA” http//www.dvdcca.org

“4C Entity, LCC” http//www.4centity.com

In these technologies, contents which are an object of the copyright are encrypted and recorded in the recording medium, and the contents which are the object of the copyright is illegally copied in such a manner that an encryption key at that point is generated as a function of inherent (ID) information of the recording medium of the object and the contents are media-bound such that the inherent ID information does not correspond to rewriting. However, when the recording medium which can be copied is present, the inherent ID information can be also illegally copied.

Since identification of the recording medium is not correctly carried out, i.e. a forgery can be made in the system capable of committing forgery, the protection of the illegal copy becomes difficult. Provision of a basic structure, in which the identification of the recording medium can not be forged, can largely improve protection performance in the protection system of the copyright. Accordingly, the improvement of the performance only in the encryption system for protecting the copyright has a limitation to the protection of the illegal copy and the like, so that it is thought that the processing of an identifying signal to the information added in conventional recording processing is effective.

It is considered that a synchronizing signal is utilized as the anti-illegal copy measure. In a method of utilizing the synchronizing signal, many kinds of synchronizing signals are required. However, there is a technology in which few kinds of synchronizing signals can be utilized in a data structure. For example, a technology of a synchronizing signal “Recording Medium and Synchronizing Signal Arranging Apparatus, Reproducing Apparatus and Reproducing Method” (Jpn. Pat. Appln. KOKAI Publication No. 8-289249) which the inventor has applied is known. This is a technology of a synchronizing signal added to an ECC block and provides a method, in which the number of kinds of the synchronizing signals is reduced to five kinds and the same arrangement is not generated at any position for the arrangement in which the three synchronizing signals are successive.

Though it is considered that the processing of identifying the medium type is carried out applying such technology, this prior art is provided in order to carry out compatible synchronizing processing while the kind of the synchronizing signal is reduced, and it is not described how the illegal copy is protected. Accordingly, in order to protect the copyright such as the contents of a DVD-ROM or the like, a specific technique is desired in the information recording apparatus and the information reproducing apparatus.

That is, when a read-only recording medium and a rewritable recording medium are present in a format having the same data structure, particularly a recording disk in which recording tracks are continued has an environment in which a forgery is easily made as a ROM disk. For example, when a recording signal in which the contents of the ROM disk are modulated is directly read out and the whole contents of the ROM disk is copied in the rewritable recording medium, the information reproducing apparatus recognizes the rewritable recording medium as the ROM disk in spite of the fact that the recording medium in which the whole content of the ROM disk has been recorded is the rewritable recording medium, and the encryption processing is directly copied, so that there is a problem that the illegal copy can not be detected.

### BRIEF SUMMARY OF THE INVENTION

An embodiment of the invention is an information recording method comprising: blocking an information and adding an error correction code to the information so as to generate an ECC block; adding plural kinds of synchronizing signals differently arranged according to a type of an information recording medium or plural kinds of synchronizing signals in which a signal pattern is differentiated according to the type of the information recording medium to the generated ECC block at a predetermined interval; and recording a recording signal based on the ECC block, to which the synchronizing signal is added, in the information recording medium.

In the information recording method according to one embodiment of the invention, the synchronizing signal added to the generated ECC block identifies the type of the information recording medium in which the ECC block is recorded. That is, using differently the synchronizing signal pattern inserted into a recording block in each type of the information recording medium, the type of the information recording medium can be determined only by observing the detected pattern of the synchronizing signal.

### BRIEF DESCRIPTION OF THE SEVERAL VIEWS OF THE DRAWING

FIG. 1 is a schematic diagram showing a structure of a disk to which medium identifying information is added at a header of one physical ECC block according to one embodiment of the invention;

FIG. 2 is a schematic diagram showing the structure of the disk to which the medium identifying information is added at the header of one physical ECC block according to one embodiment of the invention;

FIG. 3 is a schematic diagram showing a structure of a disk to which medium identifying information is added at a position except one physical ECC block according to one embodiment of the invention;

FIG. 4 shows an example of arrangement of synchronizing signal patterns of a ROM medium in which arrangement of synchronizing signal patterns according to one embodiment of the invention enables medium identification;

FIG. 5 shows an example of arrangement of synchronizing signal patterns of a rewritable medium in which the arrangement of the synchronizing signal patterns according to one embodiment of the invention enables the medium identification;

FIG. 6 shows an example of the arrangement of the synchronizing signal patterns of the ROM medium according to one embodiment of the invention;

FIG. 7 shows an example of the arrangement of the synchronizing signal patterns of the rewritable medium according to one embodiment of the invention;

FIG. 8 is a block diagram showing an example of an optical disk apparatus which operates an optical disk having the medium identifying information according to one embodiment of the invention;

FIG. 9 is a flow chart showing an example of recording action of the optical disk apparatus which operates the optical disk having the medium identifying information according to one embodiment of the invention;

FIG. 10 is a flow chart showing an example of the recording action of the optical disk apparatus which operates the optical disk having the medium identifying information according to one embodiment of the invention;

FIG. 11 is a flow chart showing an example of reproducing action of the optical disk apparatus which operates the optical disk having the medium identifying information according to one embodiment of the invention;

FIG. 12 is a flow chart showing an example of the reproducing action of the optical disk apparatus which operates the optical disk having the medium identifying information according to one embodiment of the invention;

FIG. 13 shows an example of the synchronizing signal pattern of the ROM medium in which the synchronizing signal pattern according to one embodiment of the invention enables the medium identification; and

FIG. 14 shows an example of the synchronizing signal pattern of the rewritable medium in which the synchronizing signal pattern according to one embodiment of the invention enables the medium identification.

### DETAILED DESCRIPTION OF THE INVENTION

An information recording/reproducing method, an information recording/reproducing apparatus, and a recording medium therefor, according to an embodiment of the invention, will be described in detailed below referring to the accompanying drawings.

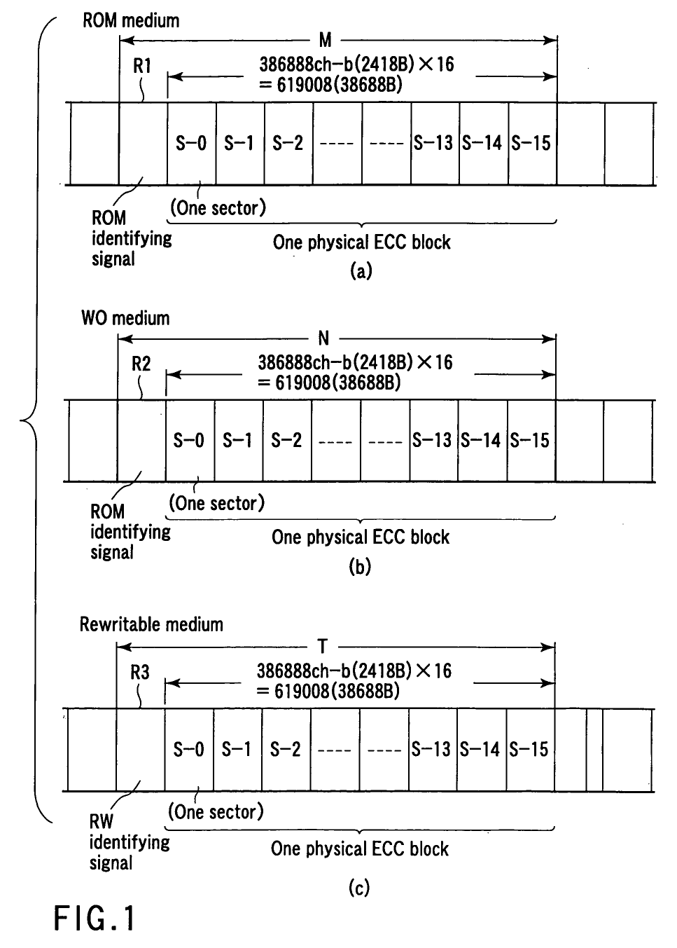

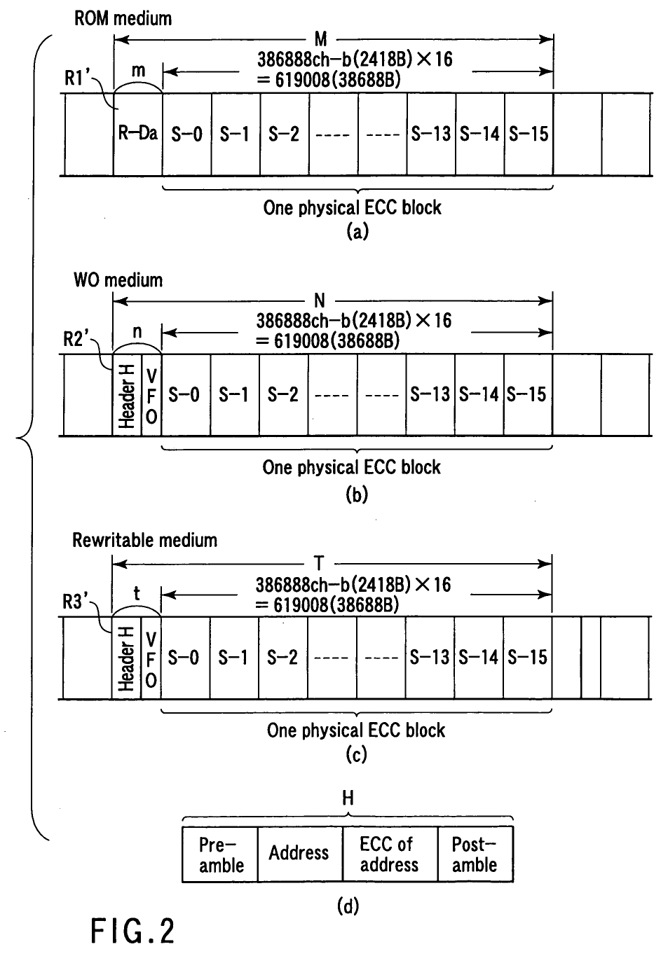

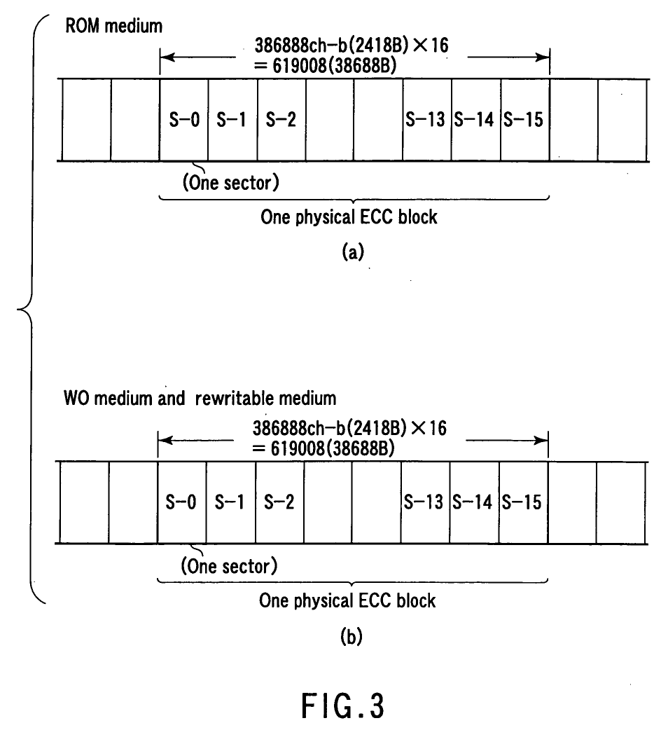

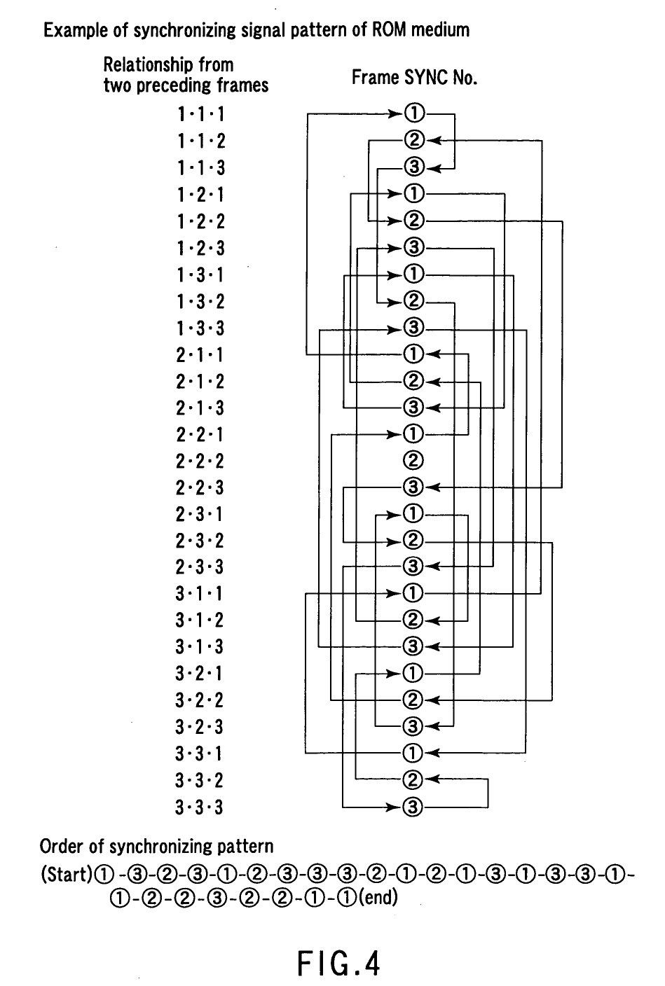

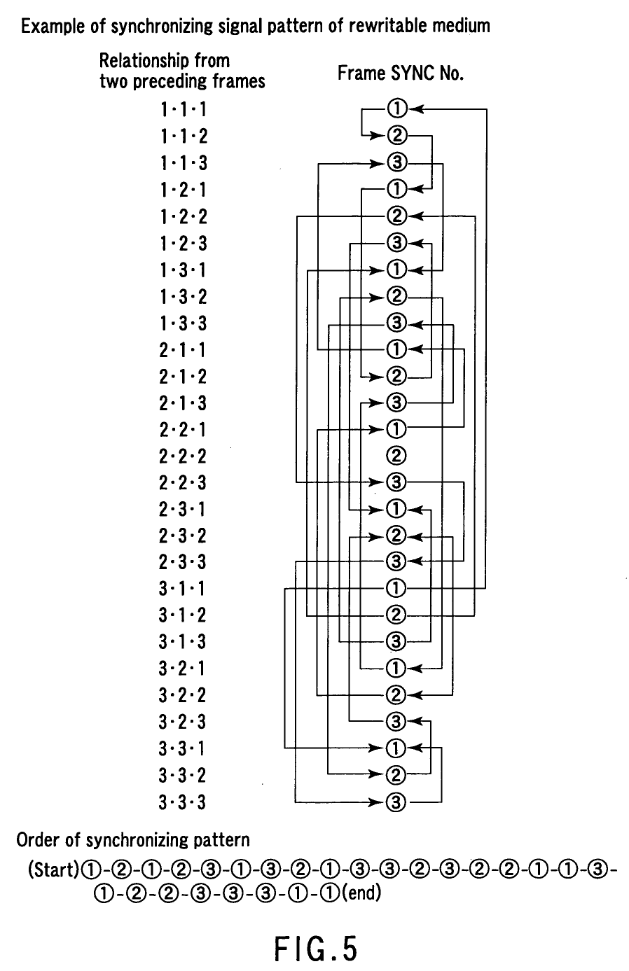

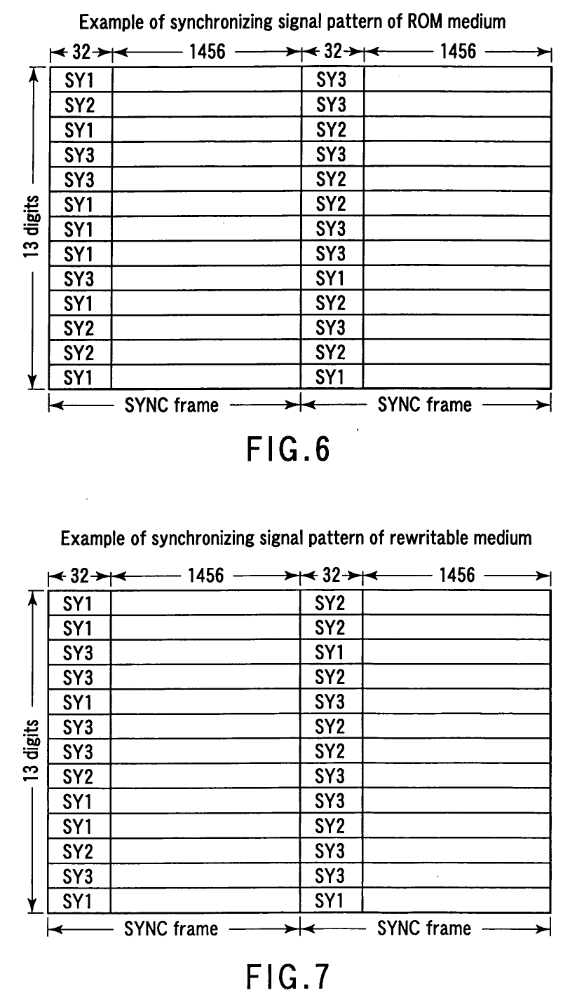

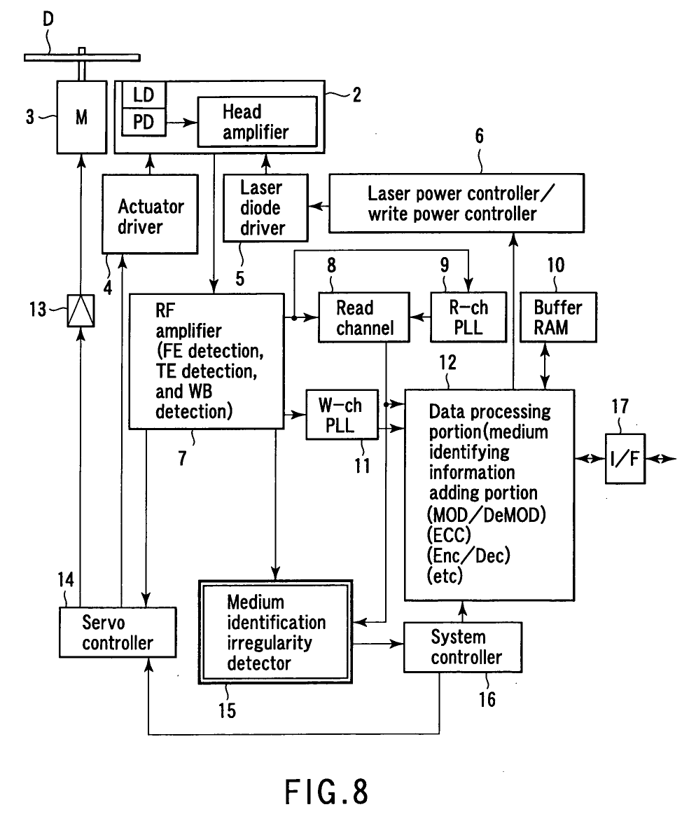

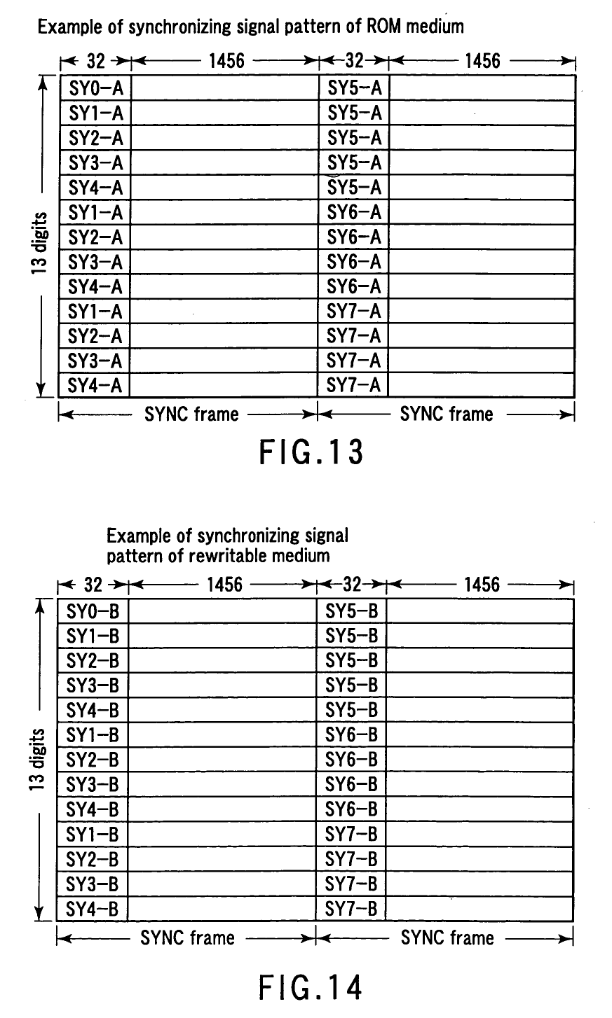

FIGS. 1 and 2 are schematic diagrams showing a structure of a disk to which medium identifying information is added at a header of one physical ECC block according to one embodiment of the invention, and FIG. 3 is a schematic diagram showing a structure of a disk to which medium identifying information is added at a position except one physical ECC block according to one embodiment of the invention. FIG. 4 shows an example of arrangement of synchronizing signal patterns of a ROM medium in which arrangement of synchronizing signal patterns according to one embodiment of the invention enables medium identification, FIG. 5 shows an example of arrangement of synchronizing signal patterns of a rewritable medium in which the arrangement of the synchronizing signal patterns according to one embodiment of the invention enables the medium identification, FIG. 6 shows an example of the arrangement of the synchronizing signal patterns of the ROM medium according to one embodiment of the invention, FIG. 7 shows an example of the arrangement of the synchronizing signal patterns of the rewritable medium according to one embodiment of the invention, FIG. 8 is a block diagram showing an example of an optical disk apparatus which operates an optical disk having the medium identifying information according to one embodiment of the invention, FIG. 13 shows an example of the synchronizing signal pattern of the ROM medium in which the synchronizing signal pattern enables the medium identification, and FIG. 14 shows an example of the synchronizing signal pattern of the rewritable medium in which the synchronizing signal pattern enables the medium identification.

<Data Structure of Information Recording Medium>

The invention provides an information recording/reproducing method and an information recording/reproducing apparatus, which, when contents information is recorded in a recordable information recording medium such as a DVD-R, reject illegal copy by adding identifying information of an information recording medium to a header of an ECC block that is recording information or by adding the identifying information of the information recording medium according to a kind of a signal pattern of at least two kinds of synchronizing signals added to the ECC block at each predetermined period or according to an order of arrangement of at least two kinds of synchronizing signals, and a recording medium therefor.

That is, in the optical disk reproducing apparatus, the illegal copy is rejected to protect the copyright of the contents such as a ROM that is a source in such a manner that, unless the identifying information added in each type of the information recording medium, the kind of the signal pattern of the synchronizing signal in the ECC block, or the identifying information of the medium which is detected by difference of the order of arrangement of the synchronizing signals and the like corresponds to sector information data of a sector block constituting the ECC block or the identifying information shown by control information of control data in a read-in area provided at an inner radius of the disk, it is determined that the disk is made by the illegal copy and the reproduction is aborted or a warning is issued.

FIGS. 1 and 2 are the schematic diagrams showing the structure of the disk to which the medium identifying information is added at the header of one physical ECC block stored in the information recording medium by the information recording/reproducing method according to one embodiment of the invention, (a) of FIGS. 1 and 2 show the structure of a ROM medium which is a playback-only recording medium such as a DVD-ROM, (b) of FIGS. 1 and 2 show the structure of a WO medium which is a write-once recording medium such as a DVD-R, and (c) of FIGS. 1 and 2 show the structure of a rewritable medium which is a recording/reproducing medium such as a DVD-RW or DVD-RAM.

(Method of Identifying Medium by Insertion of Medium Identifying Information)

FIG. 1 is the structure of the ROM medium. Unlike the conventional DVD-ROM, in each ECC block unit, ROM identifying information R1 as a block dividing signal is inserted at a header part which becomes a connection region of each ECC block. In FIG. 2, (a) shows a specific example, ROM identifying information R1′ is a randomly combined signal R-Da having a run length of n to m channel bits generated by data modulation. The random signal R-Da can be utilized for shortening lockup time of a PLL circuit in a read channel portion in such a manner as to form the random signal in which a part of the run length of the random signal R-Da, for example, the shortest run length is excluded. In the recording medium in the future, it is difficult to change from an unlocked state of the PLL circuit to a locked state due to improvement of recording density, so that the insertion of the signal helping the lockup of the PLL circuit has effect in this point.

In FIG. 1, FIG. 2, (b) and (c) show the structure of the arrangement of the recording medium, (b) of FIGS. 1 and 2 show the example of the structure of the WO recording medium such as a DVD-R, and (c) of FIGS. 1 and 2 show the example of the structure of the rewritable recording medium such as a DVD-RW or DVD-RAM. In each ECC block unit, address information or VFO of the ECC block are formed at the header which becomes the connection region of each ECC block. A recording position signal is required for the recording medium. Therefore, when a WO identifying signal R2 and a RW identifying signal R3 are arranged on the track, it differs from the signal stream of the ROM, so that it is impossible to copy the whole data in the ROM.

That is, specifically these identifying signals are a header H and VFO which have the length of n in (b) of FIG. 2, and these identifying signals are the header H and VFO which have the length of t in (c) of FIG. 2. The length of ROM identifying information of the ROM medium is m. Setting m≠n≠t, it is possible to form the identifying information of each medium according to the length of the signal. Even if these signals are set to m=n=t, it is possible to form the identifying information of the medium in such a manner as to differentiate the address signals or differentiate the arrangement of the signals of preamble, address, ECC of address, and postamble in each identification of the recording medium by using the header H shown in (d) of FIG. 2.

As described above, by adding the identifying information in manufacturing the playback-only recording medium such as a DVD-ROM or at a stage of the information recording apparatus in which the illegal copy is easily made, the type of the recording medium can be detected in the reproduction and the illegal copy is rejected.

(Medium Identification by Signal Pattern of Synchronizing Signal or Order of Arrangement of Synchronizing Signal)

According to the invention, the medium can be identified in such a manner that the signal pattern of the synchronizing signal inserted to the ECC block at every predetermined period is changed in each information recording medium.

Further, according to one embodiment of the invention, the medium can be identified by adding the medium identifying information to the order of arrangement of the synchronizing signal patterns. Accordingly, the number of signal patterns of the synchronizing signal can be reduced.

FIG. 3 shows examples of structures of recording media of a ROM medium, a WO medium and a rewritable medium respectively. It is found that the medium identifying information shown in FIGS. 1 and 2 is not inserted. In this case, as shown in FIGS. 4 and 5, the medium identifying information is added to the order of arrangement of the synchronizing signals, which are inserted at every predetermined period in each ECC of the ROM medium and the rewritable medium (and also including the WO medium that is not shown here). This is shown as the examples of the synchronizing signal patterns of the ROM medium and the rewritable medium in FIGS. 6 and 7.

Even in the current DVD standard, the synchronizing signal for signal management in the reproducing processing is inserted at every predetermined period in the ECC block shown in FIGS. 6 and 7, it shows each absolute position and the synchronizing signal can be selected at every predetermined period. In order to indicate each absolute position in one ECC block, the synchronizing signals of eight patterns from SY1 to SY8 are used in the current DVD standard.

However, as can be seen from Jpn. Pat. Appln. KOKAI Publication No. 8-289249 which has been described in the prior art, each absolute position can be indicated in one ECC block in such a manner that the eight kinds of the synchronizing signals are not always required. As shown in FIGS. 4 and 5, it is found that using only three kinds of the synchronizing signals can indicate each absolute position in one ECC block.

It should be noted at this point that each absolute position indicated by three kinds of synchronizing signals can be selected from a combination of the three kinds of synchronizing signals in at least one way (at least 36 ways in a DVD). Accordingly, the type of the information recording medium can be determined in such a manner that the order of arrangement of the synchronizing signals in the ECC block of the disk is detected by bringing the type (such as the ROM medium, the WO medium, and the rewritable medium) of the information recording medium into correspondence with the arranging way of the three kinds of synchronizing signals.

One example of the arrangement of the synchronizing signals SY1 to SY3 of the ROM medium is shown in FIG. 4. The absolute position is also shown in FIG. 4, and the arrangement shows that the ECC block is the information recorded in the ROM recording medium. That is, the arrangement of 1-3-2-3-1-2-3-3-3-2-1-2 . . . shown in a lower portion of FIG. 4 is recorded as the arrangement in the ROM medium, and the arrangement is recognized as the ROM medium even in the stage of the reproduction.

Similarly, one example of the arrangement of the synchronizing signals SY1 to SY3 of the rewritable medium is shown in FIG. 5. The absolute position is also shown in FIG. 5, and the arrangement of FIG. 5 which is different from that of FIG. 4 shows that the ECC block is the information recorded in the rewritable recording medium. That is, the arrangement of 1-2-1-2-3-1-3-2-1-3-2-1 . . . shown in a lower portion of FIG. 5 is recorded as the arrangement in the rewritable medium, and the arrangement is recognized as the rewritable medium or the WO medium even in the stage of the reproduction.

Thus, it is thought that, similar to the DVD, the ROM medium is used as authoring use which is the case of the embodiment shown in FIG. 3, in which the header region is absent in the WO medium. Even in the case, as described above, it is possible to detect the illegally-copied recording medium when the medium identifying information is added to the difference of the signal pattern of the synchronizing signals or the difference of the order of arrangement of the synchronizing signals.

Since the method in which the medium identifying information is added to the difference of the signal pattern of the synchronizing signals or the difference of the order of arrangement of the synchronizing signals can be concurrently used with the method of identifies the medium by the above-described insertion of the medium identifying information, the recording medium can be further effectively identified in the concurrent use of these method, and the illegally-copied recording medium can be surely detected.

<Information Recording/Reproducing Apparatus According to One Embodiment of the Invention>

While one example of the specific configuration of an information recording apparatus and an information reproducing apparatus for implementing the above-described two method of identifying the medium will be described referring to the drawings, its technique will be described in detail referring to the flow chart.

The description will be made citing an optical disk apparatus, which carries out recording/reproducing processing, operating an optical disk such as a DVD-ROM and DVD-R as an information recording medium.

(Configuration)

FIG. 8 is a block diagram showing an example of an optical disk apparatus which operates an optical disk having medium identifying information according to one embodiment of the invention.

The optical disk apparatus according to one embodiment of the invention has an optical pickup head (PUH) 2 (information recording portion) which irradiates an optical disk D with a laser beam and receives reflected light, an RF amplifier and servo-error detector 7 to which the signal of the reflected light is supplied, and a servo controller 14. The optical disk apparatus also has an actuator driver 4 which is controlled by the servo controller 14 and drives the optical pickup head PUH2, a read channel 8 to which an RF signal is supplied from the RF amplifier 7, and a read-channel-clock generating PLL circuit 9. Further, the optical disk apparatus has a data processing portion 12 which is connected to the R-channel PLL circuit 9, a W-channel PLL circuit 11, and a buffer RAM 10. The data processing portion 12 includes a medium-identifying-information adding portion according to one embodiment of the invention, a demodulator DeMOD, a modulator MOD, an ECC-synchronizing-signal adding portion, and various processing portions such as an encoder Enc and a decoder Dec.

The optical disk apparatus also has a medium identification irregularity detector 15 according to one embodiment of the invention, which is connected to the RF amplifier 7. A system controller 16 controls the action of each portion and the action of the whole system.

Moreover, the optical disk apparatus has a laser power controller/write power controller 6 (information recording portion) and a laser diode (LD) driver 5 (information recording portion) connected to the laser power controller/write power controller 6.

(Recording Action and Reproducing Action)

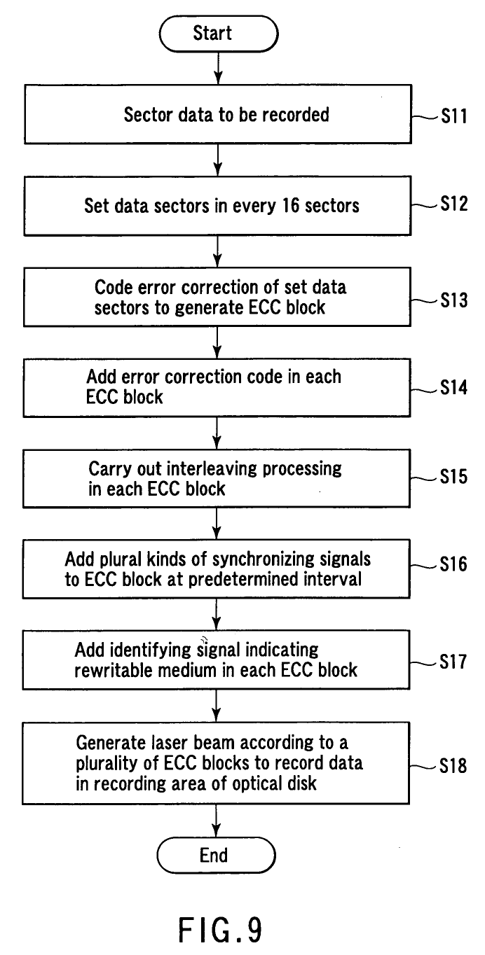

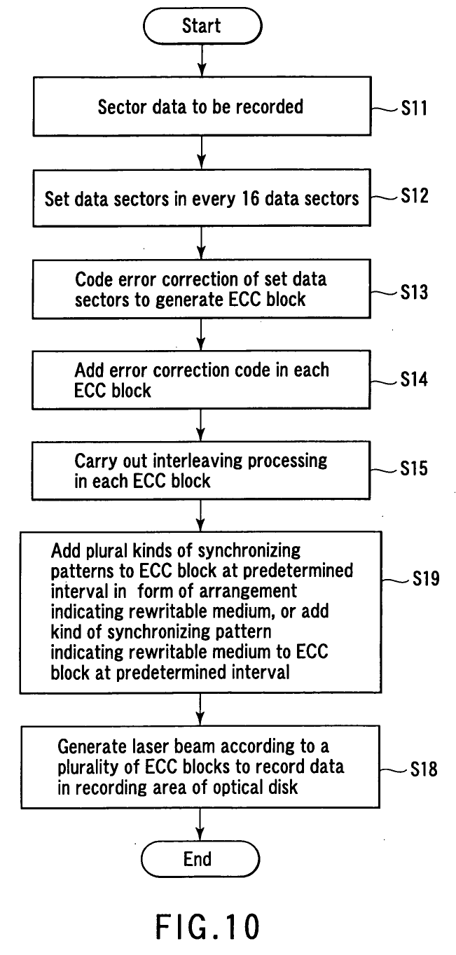

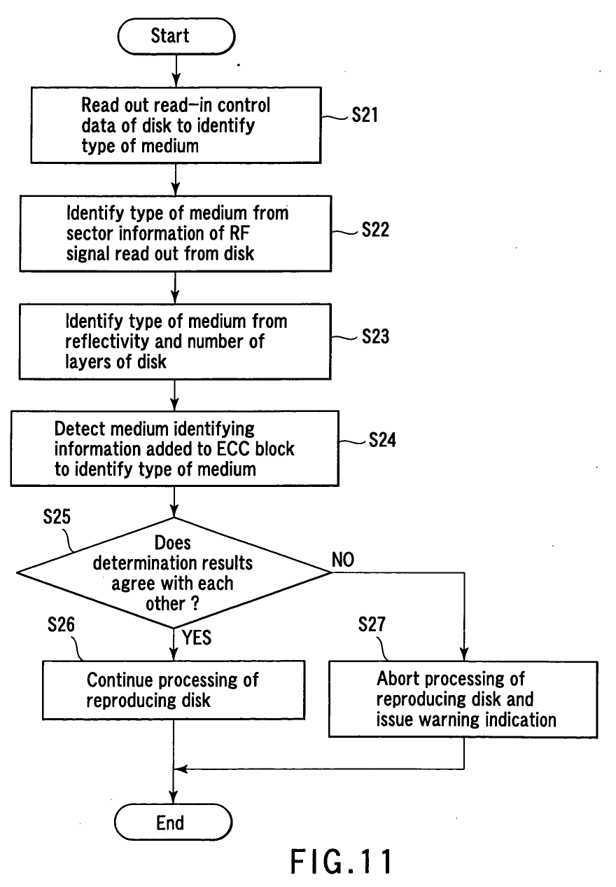

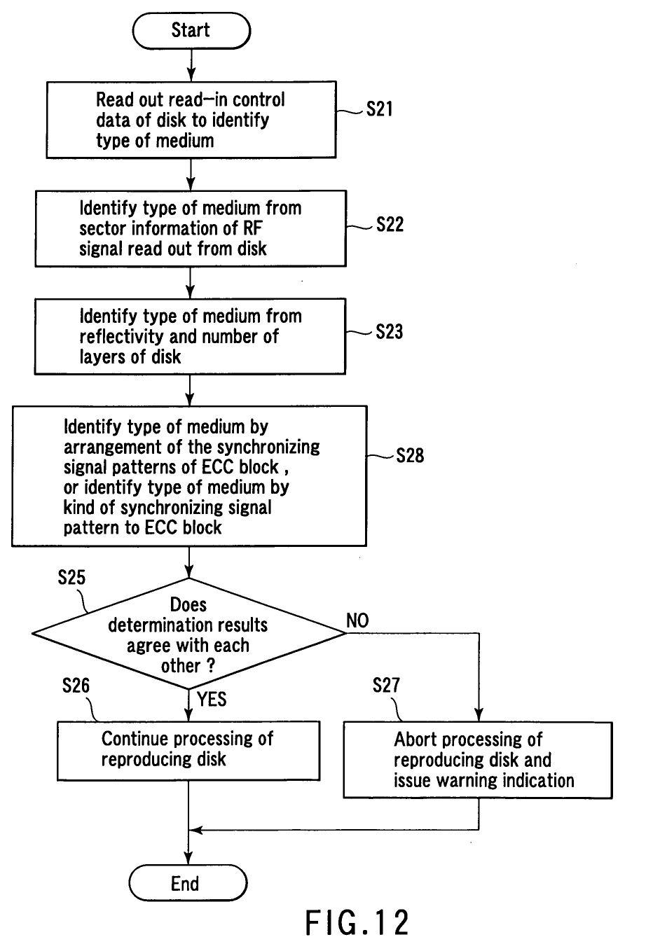

In the optical disk apparatus having the above-described structure, recording action and reproducing action are carried out as follows. FIGS. 9 and 10 are flow charts showing an example of the recording action of the optical disk apparatus which operates the optical disk having the medium identifying information according to one embodiment of the invention, and FIGS. 11 and 12 are flow charts showing an example of the reproducing action of the optical disk apparatus.

(1) Recording Action in Case of Using Medium Identifying Information

In the case that the medium identifying information shown in FIGS. 1 and 2 is used, in recording processing of the optical disk apparatus according to one embodiment of the invention, the contents transmitted from an external side through an I/F 17 are sectored by the data processor 12 under the control of the system controller 16 in the flow chart shown in FIG. 9 (S11). Data sectors are set in every 16 data sectors (S12), and error correction of the set data sectors is coded to form the ECC block (S13). An error correction code is added in each ECC block (S14), and interleaving processing is carried out in each ECC block (S15). The plural kinds of synchronizing signals are added to the ECC block at a predetermined interval (S16). Then, the medium identifying information shown in FIGS. 1 and 2 is added to the header of the ECC block, which becomes the connection region of each ECC block (S17). In the medium identifying information, the above-described various modes can be made according to the type of the recording medium. Then, the recording signal based on the ECC block is transmitted to the laser power controller 6, and the data is written in the recording medium D in such a manner that the LD driver 5 controls power of the LD in the PUH 2 (S18).

The control information such as a contents encryption key is transmitted as input information from the external side before the contents are sectored in step S11, and it is preferable that not only the contents information is encrypted by the encryption key and supplied but also multiple encryption processing is made by the medium identifying information according to the type of the optical disk D in the data processing portion 12. Further, it is preferable that the encryption key and an encryption table are also processed with the medium identifying information included.

The medium identifying information according to the type of the information recording medium can be added to the arrangement of the synchronizing signals by the recording method described above, even if the so-called dead copy in which the whole contents information in a DVD-ROM or the like is copied has been made.

(2) Recording Action in Case of Signal Pattern of Synchronizing Signals or Order of Arrangement of Synchronizing Signals

In the case that the medium identification is carried out by the arrangement of the synchronizing signal shown in FIGS. 4 to 7, in the recording processing of the optical disk apparatus according to one embodiment of the invention, the contents transmitted from an external side through the I/F 17 are sectored by the data processor 12 under the control of the system controller 16 in the flow chart shown in FIG. 10 (S11). Data sectors are set in every 16 data sectors (S12), and error correction of the set data sectors is coded to form the ECC block (S13). An error correction code is added in each ECC block (S14), and interleaving processing is carried out in each ECC block (S15). Then, the plural kinds of synchronizing signals having the arrangement according to the type of the information recording medium are added to the ECC block at the predetermined interval (S19). In this case, when the information recording medium is the information recording medium for recording the data, such as a DVD-RW, for example the plural kinds of synchronizing signals having the arrangement shown in FIGS. 5 and 7 as one example are added at the predetermined interval. The synchronizing signal may be three kinds of synchronizing signals or four or more kinds of synchronizing signals.

Alternatively, it is possible to carry out the identification by the difference of the signal pattern of the synchronizing signals by using the four kinds of the synchronizing signals among the eight kinds of synchronizing signals for the ROM medium and using other four kinds of synchronizing signals for the recording medium. The 16 kinds of signal patterns are prepared for the synchronizing signal, and the signal patterns can be distinguished by using signal patterns SY0-A to SY7-A for the ROM medium as shown in FIG. 13 and using signal patterns SY0-B to SY7-B for the rewritable medium as shown in FIG. 14 (S19).

When the optical disk apparatus is the authoring system for the DVD-ROM and the like, the plural kinds of synchronizing signals having the arrangement for the ROM medium shown in FIGS. 4 and 6 as one example is added at the predetermined interval.

Further, though it is not shown in the flow chart of FIG. 10, it is preferable that the medium identifying information shown in FIGS. 1 and 2 is added to the header of the ECC block, which becomes the connection region of each ECC block, like step S17 in the flow chart of FIG. 9. Then, the recording signal based on the ECC block is transmitted to the laser power controller 6, and the data is written in the recording medium D in such a manner that the LD driver 5 controls the power of the LD in the PUH 2 (S18).

As described above, the control information such as the contents encryption key is transmitted as input information from the external side before the contents are sectored in step S11, and it is preferable that not only the contents information is encrypted by the encryption key and supplied but also multiple encryption processing is made by the medium identifying information according to the type of the optical disk D in the data processing portion 12. Further, it is preferable that the encryption key and the encryption table are also processed with the medium identifying information included.

(3) Reproducing Action in Case of Using Medium Identifying Information

The action in reproducing the information recording medium in which the recording processing has been carried out in the above-described way will be described in detail below. In the case that the medium identifying information shown in FIGS. 1 and 2 is used, for reproducing processing of the optical disk apparatus according to one embodiment of the invention, in the flow chart shown in FIG. 11, the PUH 2 irradiates the optical disk D with the laser beam, the RF amplifier and servo error detector 7, the servo controller 14, and the actuator driver 4 act respectively after control parameters corresponding to the reproducing medium are set into each portion, and the recording signal of the optical disk D is read out by receiving the reflected light of the laser beam from the optical disk D. The read-out recording signal is supplied to the medium identification irregularity detector 15 through the RF amplifier 7, and the medium identification irregularity detector 15 reads the read-in control information of the optical disk D from the recording signal and determines the type of the disk (S21).

At this point, though it is not absolute necessity for the reproducing action in the case that the medium identifying information is used, it is preferable to read out the information determining the type of the medium from sector information included in the recording signal read out from the optical disk D (S22). That is, for example, it is possible to decide whether the disk is read-only data or the rewritable or recordable data by using bit 25 of the sector information having eight bits including bit 24 to bit 31 in ID information having 32 bits which are located in the header of each sector data, to determine the type of the disk by reflectivity which is the information of bit 29, or to determine whether the optical disk D is a ROM, DVD-R or DVD-RW by using tracking means information which is the information of bit 30 or the like. Further, it can be utilized as one of criteria determining the type of disk that the reflectivity of the optical disk D is detected and the number of layers of the optical disk D is detected. Only the ROM medium has two layers in the DVD, and the ROM medium has the high reflectivity. In the case that the reflectivity is low, it can be determined that the medium is the rewritable or recordable medium (S23).

The type of the medium is determined by extracting the medium identifying information added to the ECC block from the read-out recording signal (S24). As shown in FIG. 2, the determination at this point is made by the mode of the signal or the length of the signal according to dependence on how the medium identifying information is defined.

Then, the medium identification irregularity detector 15 determines whether the identified type corresponds to the information recording medium or not. As shown at the outset, in the case that the whole of the data of the DVD-ROM or the like is copied into other rewritable or recordable media or the like, while the read-in control information shows that the disk is the DVD-ROM, since it is determined that the disk is the rewritable or recordable medium due to the medium identifying information added to the header of the ECC block, the determination results do not agree with each other and it is detected that the illegal copy has been made (S25). Incorporation of the determination results of steps S22 and S23 into the medium identification further improves detectability of the illegal copy.

If the determination results do not agree with each other, it is preferable that the reproducing processing of the disk is aborted at this stage and warning indication that the optical disk is made by the illegal copy is carried out (S27).

If the determination results agree with each other, i.e. if it is determined that the disk is the ROM medium such as a DVD-ROM or the rewritable medium such as a DVD-RW, the usual reproducing processing is continued (S26).

That is, in the read-out signal, the RF signal is transmitted to the read channel 8 and read-channel-clock generating PLL circuit 9 from the RF amplifier 7. The RF signal is converted into a channel bit signal and transmitted with a symbolic split, a sector split, and an ECC block split mark to the data processing portion 12 by the detection of the synchronizing signal. The decoding processing and the error checking and correcting processing in ECC block unit are carried out to symbol data in the data processing portion 12.

At this point, when the encryption has been carried out by the encryption key or an encrypting technique which is different in each type of the recording medium, the multiply encrypted portion is unprotected according to the encryption by decoding the contents encryption key which has been multiply encrypted. After the above-described processing, the signal is outputted with the contents information to the external side through the I/F 17.

(4) Reproducing Action in Case of Arrangement of Synchronizing Signal or Signal Pattern of Synchronizing Signals

The reproducing action of the case in which the method of identifying the medium is carried out by the arrangement of the synchronizing signal shown in FIG. 4 to FIG. 7 will be described below referring to the flow chart shown in FIG. 12.

For the reproducing processing of the optical disk apparatus according to one embodiment of the invention, in the flow chart shown in FIG. 12, the PUH 2 irradiates the optical disk D with the laser beam, the RF amplifier and servo error detector 7, the servo controller 14, and the actuator driver 4 act respectively after control parameters corresponding to the reproducing medium are set into each portion, and the recording signal of the optical disk D is read out by receiving the reflected light of the laser beam from the optical disk D. The read-out recording signal is supplied to the medium identification irregularity detector 15 through the RF amplifier 7, and the medium identification irregularity detector 15 reads the control information added to the optical disk D in manufacturing (authoring) the disk which is present in control data in the read-in area of the disk from the recording signal and determines the type of the disk (S21).

At this point, though it is not absolute necessity for the reproducing action in the case of the arrangement of the synchronizing signal or the signal pattern of the synchronizing signal, detecting the number of layers of the optical disk D can be utilized as one of criteria determining the type of disk. Only the ROM medium has two layers in the DVD, and the ROM medium has the high reflectivity. In the case that the reflectivity is low, it can be determined that the medium is the rewritable or recordable medium (S23).

The type of the medium is determined by detecting the order of arrangement of the synchronizing signal in the ECC block from the read-out recording signal (S28). As described above, the arrangement table is the arrangement cited in FIGS. 5 to 7 as one example, and the type of the information recording medium can be determined according to the defined arrangement.

At this point, as described above, it is also possible to easily decide the type of the information recording medium in such a manner that the difference of the signal patterns is detected by using the method of differentiating the signal patterns of the synchronizing signals (the order of arrangement may be the same in this case) (S28).

In the case that pieces of medium identifying information R1 to R3 are added to the optical disk, similarly to the flow chart shown in FIG. 11, it is preferable that the medium identifying information added to the ECC block from the read-out recording signal is extracted at this point to decide the type of the medium. As shown in FIG. 2, the determination at this point is made by the mode of the signal or the length of the signal according to dependence on how the medium identifying information is defined.

Then, the medium identification irregularity detector 15 determines whether the identified type corresponds to the information recording medium or not. As shown at the outset, in the case that the whole of the data of the DVD-ROM or the like is copied into other rewritable or recordable media or the like, while the read-in control information shows that the disk is the DVD-ROM, since it is determined that the disk is the rewritable or recordable medium due to the arrangement of the synchronizing signal (or the medium identifying information added to the header of the ECC block), the determination results do not agree with each other and it is detected that the illegal copy has been made (S25). The incorporation of the determination results of the steps S22 and S23 into the medium identification further improves the detectability of the illegal copy. Further, when the medium identifying information added to the header of the ECC block can be identified, it is also included in the medium identification.

If the determination results do not agree with each other, it is preferable that the reproducing processing of the disk is aborted at this stage and warning indication that the optical disk is made by the illegal copy is carried out (S27).

If the determination results agree with each other, i.e. if it is determined that the disk is the ROM medium such as a DVD-ROM or the rewritable medium such as a DVD-RW, the usual reproducing processing is continued (S26).

In the optical disk apparatus according to one embodiment of the invention in which the above-described reproducing processing is carried out, by the action of the medium identification irregularity detector 15, it is determined from servo parameter information detected at initial stage in the reproduction, the synchronizing signal pattern, connection information of split point of the ECC block, or the like whether the information recording medium is the read-only medium or the rewritable or recordable medium, and it is determined whether the sector information, book type information written in the control information of the read-in area in the DVD standard, or the like is legal or illegal. When an illegal item is found, the illegal copy can be effectively rejected in such a manner that the reproduction is aborted or the warning processing is carried out. Accordingly, even for the dead copy in the RF area (channel bit area) of the ROM, which is recognized to be difficult to detect it in the related art, the protection of the copyright in the disk contents of the copy source can be surely made by detecting and rejecting the dead copy in the RF area of the ROM.

While those skilled in the art can realize the invention by various embodiments described above, it will be easily understood by those skilled in the art that various modifications of such embodiments can be made, and it is possible without any inventive ability to apply various embodiments. Accordingly, the invention covers a wide range consistent with disclosed principles and novel features, and the invention is not limited to the above-described embodiments.

For example, though the above description has been made by citing the DVD which is the optical disk, the invention can be applied to other information recording media within the scope of the invention.

As described above in detail, the invention can provide the information recording/reproducing method and the information recording/reproducing apparatus, in which the illegal copy is detected by simultaneously recording the type information of the recording medium, in which data is recorded, into the recording medium in the recording processing of the contents and by detecting the type information with the reproducing apparatus, and consequently, the reproducing processing can be aborted or the warning can be issued, and the information recording medium.

What is claimed is:

1. An information recording method comprising:
blocking an information, and adding an error correction code to the blocked information so as to generate an ECC block;
adding plural kinds of synchronizing signals differently arranged according to a type of an information recording medium or plural kinds of synchronizing signals having different signal pattern according to the type of the information recording medium, to the generated ECC block at a predetermined interval; and
recording a recording signal based on the ECC block, to which the synchronizing signal is added, in the information recording medium.

2. An information recording method according to claim 1, wherein at least a rewritable information recording medium and a read-only information recording medium are distinguished by arrangement of the plural kinds of synchronizing signals to be added.

3. An information recording method according to claim 1, wherein the synchronizing signals to be added are at least three kinds of the synchronizing signals, a combination of the three synchronizing signals is thoroughly differentiated such that a position of the synchronizing signal in the ECC block can be identified by a combination of three synchronizing signals, that is, one synchronizing signal, the immediately preceding synchronizing signal, and the synchronizing signal in two preceding synchronizing signals, and an order of the arrangement of the synchronizing signals in the ECC block is determined corresponding to the type of the information recording medium.

4. An information recording method according to claim 1, wherein the information to be recorded is encrypted by an encryption method according to the type of the information recording medium and divided into blocks.

5. An information recording method comprising:
blocking information to be recorded, and adding an error correction code to the information to generate an ECC block;
adding medium identifying information showing a type of an information recording medium to the generated ECC block; and
recording a recording signal based on the ECC block, to which the medium identifying information is added, in the information recording medium.

6. An information recording method according to claim 5, wherein the medium identifying information is written in a connection region of said plurality of ECC blocks, the connection region has a length according to the type of the information recording medium, and a VFO (Variable Frequency Oscillator) signal or a random signal is recorded in the connection region.

7. An information recording method according to claim 5, further comprising adding plural kinds of synchronizing signals differently arranged according to the type of the information recording medium or plural kinds of synchronizing signals in which a signal pattern is differentiated according to the type of the information recording medium to the generated ECC block at a predetermined interval.

8. An information recording method according to claim 5, wherein arrangement of the medium identifying information is different depending on whether the information recording medium is a read-only medium or a rewritable medium.

9. An information recording method according to claim 5, wherein, in the medium identifying information, only a VFO (Variable Frequency Oscillator) signal is recorded when the information recording medium is a read-only medium.

10. An information recording method according to claim 5, wherein, in the medium identifying information, only a random signal is recorded when the information recording medium is a read-only medium.

11. An information reproducing method comprising:
reading out control information, which is stored in an information recording medium and added in manufacturing or authoring the information recording medium, and thereby determining a type of the information recording medium;
determining the type of the information recording medium on the basis of an order of arrangement of plural kinds of synchronizing signals included in an ECC block read out from the information recording medium or on the basis of a signal pattern of the synchronizing signal; and
determining whether or not the type based on the control information in the manufacturing or the authoring corresponds to the type based on the synchronizing signal, and if the type based on the control information corresponds to the type based on the synchronizing signal, reproduction of the ECC block is carried out, and if the type based on the control information does not correspond to the type based on the synchronizing signal, the reproduction is aborted.

12. An information reproducing method according to claim 11, wherein the synchronizing signal is a synchronizing signal having at least three kinds of signal patterns, a position of the synchronizing signal in the ECC block can be identified by a combination of three synchronizing signals. that is, one synchronizing signal, the immediately preceding synchronizing signal, and the synchronizing signal in two preceding synchronizing signals, and the type of the information recording medium is identified by the order of arrangement of the synchronizing signals in the ECC block.

13. An information reproducing method comprising:
reading out at least control information added in manufacturing or authoring an information recording medium from the information recording medium, and thereby determining a type of the information recording medium;
reading out medium identifying information added to an ECC block read out from the information recording medium, and thereby determining the type of the information recording medium; and
determining whether or not the type based on the control information in the manufacturing or the authoring corresponds to the type based on the medium identifying information, and if the type based on the control information corresponds to the type based on the medium identifying information, reproduction of the ECC block is carried out, and if the type based on the control information does not correspond to the type based on the medium identifying information, the reproduction is aborted.

14. An information reproducing method according to claim 13, further comprising determining the type of the information recording medium on the basis of an order of arrangement of plural kinds of synchronizing signals included in the ECC block read out from the information recording medium or on the basis of a signal pattern of the synchronizing signal; and
determining whether or not the type based on the control information in the manufacturing or the authoring, the type based on the medium identifying information, and the type based on the synchronizing signal correspond, and if the three types correspond, reproduction of the ECC block is carried out, and if the three types do not correspond, the reproduction is aborted.

15. An information recording apparatus comprising:
an ECC block making portion which blocks an information and adds an error correction code to the information so as to generate an ECC block;
a synchronizing signal adding portion which adds plural kinds of synchronizing signals differently arranged according to a type of an information recording medium or plural kinds of synchronizing signals in which a signal pattern is differentiated according to the type of the information recording medium to the ECC block generated by the ECC block making portion at a predetermined interval; and
an information recording portion which records a recording signal based on the ECC block, to which the synchronizing signal is added, in the information recording medium.

16. An information recording apparatus comprising:
an ECC block making portion which blocks information to be recorded and adds an error correction code to the information to generate an ECC block;
an identifying information adding portion which adds medium identifying information showing a type of an information recording medium to the ECC block generated by the ECC block making portion; and
an information recording portion which records a recording signal based on the ECC block, to which the synchronizing signal is added, in the information recording medium.

17. An information reproducing apparatus comprising:
a medium identifying portion which reads out at least control information added in manufacturing or authoring an information recording medium from the information recording medium thereby to determine a type of the information recording medium, and determines the type of the information recording medium on the basis of an order of arrangement of plural kinds of synchronizing signals included in an ECC block read out from the information recording medium or on the basis of a signal pattern of the synchronizing signal; and
a medium irregularity detecting portion which determines whether or not the type based on the control information in the manufacturing or the authoring corresponds to the type based on the medium identifying information, and if the type based on the control information corresponds to the type based on the medium identifying information, carries out reproduction of the ECC block, and if the type based on the control information does not correspond to the type based on the medium identifying information, aborts the reproduction.

18. An information reproducing apparatus comprising:
a medium identifying portion which reads out at least control information added in manufacturing or authoring an information recording medium from the information recording medium thereby to determine a type of the information recording medium, and reads out medium identifying information added to an ECC block read out from the information recording medium thereby to determine the type of the information recording medium; and
a medium irregularity detecting portion which determines whether or not the type based on the control information in the manufacturing or the authoring corresponds to the type based on the medium identifying information, and if the type based on the control information corresponds to the type based on the medium identifying information, carries out reproduction of the ECC block, and if the type based on the control information does not correspond to the type based on the medium identifying information, aborts the reproduction.

19. An information recording medium, wherein a plurality of ECC blocks, each of which has plural kinds of synchronizing signals differently arranged according to a type of the information recording medium or plural kinds of synchronizing signals in which a signal pattern is differentiated according to the type of the information recording medium at a predetermined interval, are recorded.

20. An information recording medium, wherein a plurality of ECC blocks, to which medium identifying information showing a type of the information recording medium is added, are recorded.
